(19) United States
(12) Patent Application Publication
(10) Pub. No.: US 2025/0007741 A1
(43) Pub. Date: Jan. 2, 2025

(54) SYSTEMS, METHODS, AND COMPUTER READABLE MEDIUM FOR CONTROLLING BLOCKCHAIN OPERATION

(71) Applicant: Omnumi, Inc., Greenville, SC (US)

(72) Inventors: Kirk Stewart Chapman, Greenville, SC (US); Sree Charran Tirumalasetti, Arnold, MO (US); lzzet Can Akkus, New York, NY (US)

(21) Appl. No.: 18/750,863

(22) Filed: Jun. 21, 2024

Related U.S. Application Data
(60) Provisional application No. 63/608,692, filed on Dec. 11, 2023.
(60) Provisional application No. 63/511,344, filed on Jun. 30, 2023.

(51) Int. Cl. H04L 9/00; H04L 9/32

(52) U.S. Cl. CPC H04L 9/50; H04L 9/3213

(57) ABSTRACT

Systems, methods and computer readable medium that are configured to perform blockchain ledger operations. A private blockchain network is implemented in connection with other features such as access to the ledger or portions of ledge information to verify accuracy. The system can include integration with user computer devices wherein the system implements rules on servers such as behind the private blockchain (e.g., as opposed to just on personal computer devices). The behind the blockchain servers can process access and use of the blockchain. The system can include multiple parallel rules engines.

### CROSS-REFERENCE TO RELATED APPLICATIONS

This application claims priority to U.S. Provisional Patent Application No. 63/608,692, filed Dec. 11, 2023, and U.S. Provisional Patent Application No. 63/511,344, filed Jun. 30, 2024, the entire contents of each of these applications are incorporated herein by reference.

### FIELD OF THE INVENTION

This application is related to the field of cryptographic tokens and in particular to new blockchain networks and features.

### BACKGROUND

Known systems follow a design in which regulation over a transaction is implemented at the user's digital wallet, e.g., before the blockchain, but this approach has drawbacks such as a security issues that permit the local users to bypass the restriction or an architecture that makes updating and maintaining the controls potentially slow, difficult, or unreliable.

### BRIEF SUMMARY OF THE INVENTION

In accordance with the principles of the present invention, systems, methods, and/or computer readable medium are provided that implement a blockchain that is configured to regulate token transfers (e.g., involving messaging and related procedures for transmitting a token and maintaining a distributed ledger to track token transfers).

For example, in one or embodiments a system is implemented including a plurality of computer nodes that are configured to be private computers and to form a blockchain that operates cooperatively in accordance with a decentralized peer-to-peer blockchain consensus protocol that governs creating, transferring, and maintaining a history of a particular token type resident on that blockchain.

The system can include a service server that is configured to receive information from a plurality of electronic software applications (such as digital crypto wallets), wherein the software application are configured to securely store user data as an electronic container and the user data includes encryption keys that are assigned to the user of that software application to control access in association with the particular token type on that blockchain and, wherein the service server is configured to store user registration and user identification and is further configured to store a corresponding identification tier from a plurality of tiers.

In the system, the blockchain is configured receive a new token transfer request message and, to proceed (e.g., only proceed) when the identity of the user that sent the request message and receiving user are known by the service server. In the system, the computer nodes on the blockchain are configured to direct the request message to an off-chain computer, wherein the off-chain computer is configured to include a rules engine comprising different sets of rules directed to providing dynamic evaluation of transfer request messages. A portion of the rules are structured to vary as a function of the identification tier of the user that sent the request message or receiving user, and another set of rules are configured to apply other rules controlled by external electronic access to the rules engine (e.g., direct access to add or modify rules).

The system implements an automatically executable set of code, that can be a smart contract, stored and executable on the blockchain, wherein the automatically executable set of code is configured to receive the output of the rules engine and is configured to have the system block or proceed with a new token transfer as specified in the new token transfer request message. In response to determining to proceed, the blockchain uses a consensus protocol defined in the decentralized peer-to-peer blockchain consensus protocol to record on the blockchain the token transfer. In the system, the protocol configures the nodes to respond to requests to receive blockchain audit data sent from public computers (e.g., a computer connected to the Internet and that is not part of the private blockchain computers/network and which computer may be seeking to obtain ledger related information from the private blockchain computers/network by way of an Internet connection to the private computers/network using Internet protocol standard communications such as using get command). The public computer may be the service server illustratively discussed herein. If desired, the general public using their personal computers that have access to the Internet can send requests to private nodes of the blockchain such as an anonymous request.

The service server may be configured to administer (e.g., add, remove, modify, etc.) the plurality of computer nodes. The protocol may be used to configure the nodes to send data stored on the blockchain to requesting public computers (e.g., an anonymous request or request from a trusted computer). If desired, the nodes may be configured to provide the data without requiring login credentials from requesting public computers. The system may include an application program interface implemented on personal devices to participate in the operation on the blockchain. The system may include a computer that is configured to intercept messages sent to the blockchain and directs one or more of the messages to the off-chain computer. The system may be configured to include a plurality of separate different rules engines that are controlled or defined by different external computers so as to have parallel operating rules engines that are implemented to operate on message requests based on request properties.

By way of additional examples, in one or more embodiments a system is implemented that includes a plurality of computer nodes that are configured to be private computers and to form a blockchain that operates cooperatively in accordance with a decentralized peer-to-peer blockchain consensus protocol that governs creating, transferring, and maintaining a history of a particular token type resident on that blockchain. Private computer means the computers are in the same domain or are under the private control by a central entity.

The system can include a service server that is configured to receive information from a plurality of electronic wallets and store user registration and user identification. The service server can be further configured to store a corresponding identification tier from a plurality of tiers for each user.

In operation, one or more embodiments are configured to have the blockchain receive a new token transfer request message and, to proceed when the identity of the requesting and benefitting users are known by the service server. The computer nodes on the blockchain are configured to direct the request to an off-chain computer that is configured to include a rules engine comprising different sets of rules directed to providing dynamic evaluation of transfer request messages, and wherein a portion of rules are structured to vary as a function of the identification tier of the requesting or benefitting user, and another set of rules are configured to apply other rules controlled by third party electronic access to the rules engine.

The protocol implements a smart contract that receives the output of the rules engine and is configured to instruct the blockchain to terminate or proceed with a new token transfer as specified in the new token transfer request message. In response to determining to proceed, the blockchain uses a consensus protocol defined in the decentralized peer-to-peer blockchain consensus protocol to record on the blockchain a token transfer from the requesting digital wallet (application) to the receiving digital wallet (application). The protocol can configure the nodes to respond to data audit request from public computers. This refers to providing access to computers that are not private nodes (e.g., computers on the Internet that are not part of the private blockchain) and the protocol permits such other computer to access the data (such as by the service server accessing the data on the blockchain network to make it available to other computers) so as to make data open.

The arrangement and configuration of the system may be configured to provide real time or live processing of transactions such that transfer requests are processed and completed on the blockchain in close proximity in time or instantaneous as requests are received based on the efficiency and/or performance provided by the system.

As would be understood, corresponding or counterpart method and computer readable medium embodiments are understood and contemplated.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 is a functional block diagram of a system including, among other things, a blockchain network in accordance with one or more embodiments of the present invention;

FIG. 2 is a functional block diagram and process flow diagram illustrating an electronic wallet to wallet transaction in accordance with one or more embodiments of the present invention;

FIG. 3 (meaning FIGS. 3A and 3B collectively) is a functional block diagram and flow chart illustrating token ledger systems in accordance with one or more embodiments of the present invention; and

FIG. 4 (meaning FIGS. 4A and 4B collectively) is a functional diagram and flow chart illustrating the flexibility of the rules engine in accordance with one or more embodiments of the present invention.

### DETAILED DESCRIPTION OF THE INVENTION

The terminology used herein is for the purpose of describing particular embodiments only and is not intended to be limiting of the intention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing embodiments of the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Embodiments of the present invention include advantages or improvements over known systems and methods in the field of crypto digital wallets and blockchain systems and operation. As mentioned, known existing system implementations of aspects, such as security or control at the digital wallet was found to provide poor security because people could find ways around the feature. In addition, updating or maintaining wallet level features was difficult because of the distributed nature (e.g., similar to filtering web content implemented at the client computer). In aspects of embodiments of the system, illustratively described herein, the system implements operations (e.g., restriction or control over the operation on the wallet) in the network such as by way of a rules engine implemented on the network. This approach can avoid the security concern of the user bypassing the feature and provides quicker or easier access for updating the rules engine or similar features “centrally.” Another known issue with blockchain operation and security has to do with the speed of operation. The distributed process that involves operating nodes to update information in a ledger can be time-consuming and slow. For example, known systems use public nodes to implement the distributed ledger and perform a particular protocol process to assure accuracy. These blockchains can be relatively slow to complete a desired operation related to updating records. Embodiments of the present invention implement a private-public approach and related details such as by using a private network of blockchain nodes to provide improved security and consequently speed of operation. In the public sense, the systems are configured to have the private network be also public in that, for example, data (or certain specified data) in the blockchain ledger can be retrieved by public computers to perform a verification process (independently). In this approach, in practice, some of the processing burden by way of protocol operation needed for a public network to run a secure and transparent process using a public blockchain is eliminated. This provides a secure faster approach and publicly verifiable approach. In another aspect, embodiments of the system include features that are configured to adapt the blockchain to include complex processes (relative to smart contracts) without making the operations subject to the speed and protocol limitations of the blockchain by directing blockchain transfer requests to systems sitting behind the blockchain (e.g., accessed through the blockchain) that can more quickly perform the complex operations (e.g., compliance, personal transaction limits, and/or government rules, etc.). Another feature integrates a message interceptor and/or message broker to incorporate such features. The combination of these and other features (or feature individually) include implementation details that provide improvements, practical deployment, or other technical advances (e.g., compared to the conventional approaches).

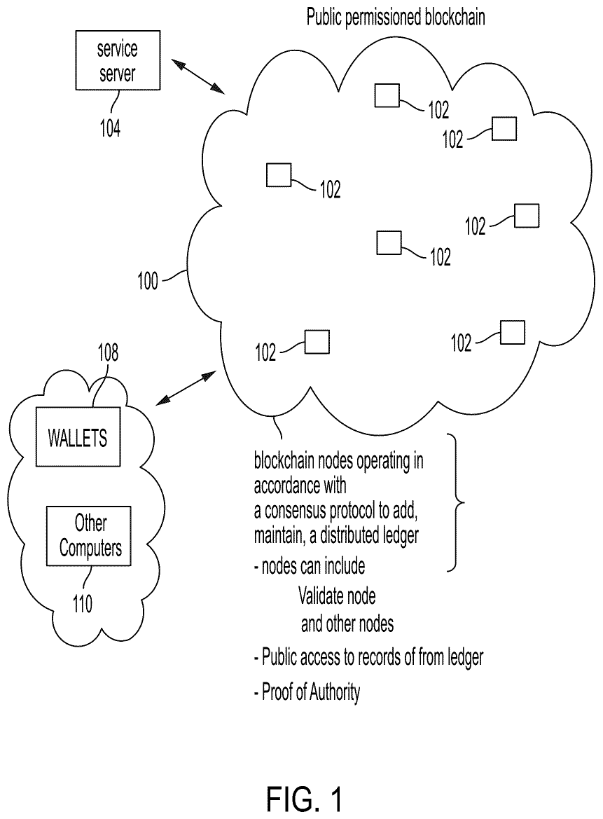

With reference now to FIG. 1, a system is illustrated to demonstrate certain aspects of embodiments of present invention. Blockchain network 100 is configured to operate in accordance with a permissioned blockchain protocol (e.g., a public permissioned blockchain protocol) and includes a plurality of nodes 102 (computer nodes). It should be understood that there may be many more nodes 102 implemented in the blockchain network 100 beyond the few illustrated in FIG. 1. The protocol defines the actions, responsibilities, and interaction of the nodes 102 to provide a permissioned blockchain or public permissioned blockchain. The blockchain nodes 102 operate in accordance with a consensus protocol (the nodes 102 execute the consensus protocol) used to authenticate the data transactions and record blocks. Blockchains (blockchain networks) are decentralized peer-to-peer networks with a shared append-only (electronic) ledger maintaining a consensus through a protocol. The ledger is stored in a distributed manner on the blockchain network using files or records stored on the nodes on the blockchain network. In a blockchain, transactions are recorded as blocks of data. Each block contains transaction data and is cryptographically hashed. The blocks can include a hash of the previous block in the chain. The data stored in blocks can include automatically executable code, smart contracts. For the sake of brevity, since blockchain networks and related consensus protocols are generally known to those of ordinary skill in the art, a discussion of features of such networks and protocols are not always presented herein.

Blockchain network 100 is configured to operate a permissioned blockchain network. This configuration provides that the nodes that make up the blockchain network 100, such as, nodes 102 are under the same network domain; that is the nodes that execute the protocol and maintain the information in the ledgers are controlled by the same entity or administrator and the network is configured to only allow that (single) entity/administrator to add, remove, or modify nodes. The blockchain network 100 comprises a peer-to-peer network protocol that automatically operates the interactions between peer nodes but the administrator/entity's system or control system is configured to have administrative control over the nodes such as to activate or deactivate, perform or review diagnostics, and/or retrieve status of the nodes. For example, service server 104 can be configured to implement, install, initiate, control, update, activate, deactivate, or manage (through messaging) nodes 102 because service server 104 includes stored access credentials for the domain and nodes 102 to carry out such electronic actions. Preferably, service system 104, or in other words, a single system of authority, controls all of the nodes that form the blockchain network 100.

Blockchain network 100 may be configured to be public with respect to providing access to the ledger, distributed records, created and maintained by the blockchain network 100 such as by configuring nodes 102 or other nodes on the blockchain network 100 to make the records available for review through an intermediary server (such as service server 104) that is configured to retrieve, log, or request the transaction, ledger, or other blockchain information (such as for auditing purposes). For example, the nodes 102 may be configured to receive requests from other computers (that are not part of the blockchain network 100) such as the service server 104 to send information contained in the ledger or records maintained by the blockchain and in response, the nodes 102 (e.g., an individual node 102 that received the request) are configured to send a message in response that provides the information. Nodes 102 are configured under the blockchain protocol to respond to the requests when the request meets the protocol requirements of that blockchain network and can do so to a request from another computer that is on the Internet. In some embodiments, the service server 104 is configured to communicate with a plurality of servers on the Internet and provide ledger information from the blockchain to those servers based on some form of authorization, trust, or authentication with those servers (e.g., each server may have an associated set of users/wallets that the server added, in concert with the service server 104) to use (e.g., transfer tokens) with the blockchain 100. In some embodiments, blockchain nodes can be configured to respond to data requests providing ledger information without requiring the requesting computer to provide credentials or establish another form of trust with the blockchain nodes.

Wallets 108 are depicted as a single box for simplicity but reflects that there can be many separate digital wallets such as cryptocurrency wallets that are installed on user-computer devices (or personal computer devices) such as mobile phones. Wallets 108 are software applications that are configured to securely store data for the user as an electronic container and the data can include encryption keys such as a public and a private encryption key that is assigned to the user of the wallet in association with cryptographic tokens of a particular blockchain. The electronic container and application is configured to interact with the user to send and receive messages to a blockchain to process (receive or send) crypto tokens securely using the associated blockchain network. Each wallet 108 is configured to have its own network address for messaging. Wallet(s) 108 are configured to provide electronic custody of a user's crypto tokens, which for the most part will be referred to as cryptocurrency. The custody can be configured to provide, by having the encryption keys for the tokens, the current total or status of token owned or assigned that can be maintained on the blockchain. The wallet can reside only on the user's device such as the user's mobile phone (which can include the use of supporting storage such as cloud services). Wallet(s) 108 can be configured to allow the user to store a single or different types of cryptocurrency and be able to conduct transactions (moving) stored cryptocurrency using the wallet 108. For example, a wallet may be used to store Ethereum, Bitcoin, or other crypto currencies that are owned by the user of that wallet. Storing other or additional types can be implemented in the system and wallets.

In the current general convention and known implementations, wallets and cryptocurrencies are configured to enable or allow the anonymous use and transfer of cryptocurrency. This can be performed by having the address for the wallet and using a private key and public key for the wallet to transfer tokens. In many cryptocurrencies, the identity of the cryptocurrency owner is not used or needed for transferring tokens on the blockchain for that currency. In such wallets, the electronic wallets are configured to store cryptocurrencies (store records that can evidence or verify the receipt or transfer of tokens, the current state of tokens for that wallet, on blockchain) and may not require identity determination or other restrictions to use the wallet or use the tokens in the wallet for processing activities on the blockchain network. Anonymity has been an important aspect of the blockchain and cryptocurrency. Wallets in general are configured to support the use in owning any kind of cryptocurrency. In some known wallet system, the wallet is configured to require some form of credentials and include processes that apply a set of rules to check the transaction to authorize the wallet to proceed with a transaction on that particular blockchain. In general, the prior direction or known approach of the technology has been to integrate into the wallets features such as to review a particular blockchain requests. This can for example allow for flexibility to the wallet to work with any cryptocurrency, but has disadvantages such as with respect to security.

Other computers 110 are representative of other computers that may be involved in interactions with the service server 104, blockchain network 100, or wallets 108. For example, other computers 110 can represent computers that provide or verify identity of users, wallet, and/or entities such as by verifying different levels of identity or confirming or establishing the identity of the registrant. This can be by a government or commercial entity's computers that, for example, verify a driver's license, user images, address, account activity, or other user information that the service system can use in establishing higher levels of confidence that the registered user and the user's submitted identity and the actual real-life identity are the same. Other computer 110 can include computers that are configured to be computers owned or operated by or for governments or government representing entities. These computers can be configured to, for example, add or update rules that meet that jurisdiction's rules for activity permitted to be performed on the blockchain network 100. Other computers 110 can include computers implemented by an enterprise (a company) or entity to implement rules that are applied to users of that enterprise or entity. For example, a company may have issued cryptocurrency (tokens) to certain employees and the company may use the employees' wallets in combination with the service system to apply control to the employee actions on the blockchain network 100. The company's servers may be configured to register and authenticate the user such as to be an employee. In response, the company's servers are configured to provide a private key for use on the blockchain to each user in connection with a wallet (e.g., of the user's choosing—wallet independent) and provide a public key to the blockchain system. The wallets will use the public and private keys to perform transactions on the blockchain network 100 subject to the operations or restrictions illustratively described herein. The wallet and/or user would have been authenticated by the company's server and at least by the company server providing the keys, the authentication (and/or identity determination) is indirectly provided to (and used by) the blockchain system. Thus, a login directly by users/wallets with the service server or blockchain network 100 would not be necessary (although possible if desired).

The blockchain network 100 is preferably implemented on the Internet or is accessible/connected to the Internet. The wallets 108, other computers 110, and service server 104 are preferably implemented to be on the Internet or are accessible/connected to the Internet. The connectivity or configuration permits the communication messaging between the described computers to occur using, for example, standard Internet communication protocols.

As mentioned, blockchain network 100 and service system 104 are configured to mint a particular on-chain cryptocurrency that resides and is managed by the blockchain network 100. This, for example, is similar to the corresponding networks that run and manage Bitcoin, Ethereum, or Dogecoin. Owners of that token must use that corresponding blockchain network for executing transaction or processes on that particular blockchain network. These are the correspondingly configured blockchain network for its cryptocurrency (crypto token is created by that blockchain is resident for use in processes in that blockchain). Wallets are configured to interact with the corresponding blockchain network for that on-chain cryptocurrency.

The wallet users are registered users such as by being registered with other computers 110 (e.g., a company using a company server such as a server of a bank that is “on” the blockchain network 100 and is in trusted communication with the service sever 104 in supports of the wallets associated with the company server). In the registration process, credentials such as login ID and passwords may be saved for the registered user to allow the user to exercise services available on the blockchain network 100 and by the service server 104. A registration process or data collection process can collect additional information about the user such as an image, driver's license number (or driver's license image), passport information, secure ID details (e.g., involving SSI) (or additional identifying information) are collected and used to verify the identity of the current user such as by interacting with one or more other computers 110. In some embodiments, the registration can be with or include the service server 104.

Preferably, activities such as processing transactions on blockchain network 100, which has its own resident crypto tokens, are only made available to or exercised by registered users. For example, the users can only transfer the resident token between their respective wallets when they are both registered users and/or their identity has been verified using SSI (“self-sovereign identity”). The resident crypto token and related protocol of that blockchain is adapted to be integrated with supporting services that check user identity and apply rules to determine whether to proceed with the transaction. This integrates additional procedures that are not part of conventional cryptocurrencies. Conventional cryptocurrencies are configured to use the consensus protocol to automatically carry out a transaction when a request is received in the peer-to-peer network without checking identity or transactions rules on the blockchain side.

In operation, the computer device that contains the wallet can be configured to use an application program interface (“API”) or an interface application configured interact with other computers to login a registered user of the wallet once that user, for example, previously registered and had his or her identity verified (e.g., using third party electronic resources). Authentication credential and identity are not necessarily the same. An identity refers to the actual identity of a user who may have anonymous authentication login credentials. This API approach (one embodiment) can be advantageous, for example, to allow the user to install a wallet that is generic such that it can hold a range of different cryptocurrencies. In this example, for the cryptocurrency of blockchain network 100, the API or interface application is called when the transaction is started so as to login the registered. The API or interface application can for example interact with the service server 104 to login the registered user (to recognize the user). In some embodiments, the wallet application that implements that the wallet can be configured with internal software that implements the API or interface application in the wallet application (as opposed to the wallet communicating through an API or with another application on the computer device that has the wallet installed). In some embodiments, the “behind” the blockchain networks can be use the key information associated with a request to transfer tokens to determine whether the key information remains active with a company or entity on the blockchain network.

The system (e.g., blockchain 100 and supporting features) is configured to be a noncustodial system in that the blockchain 100 and service server 104 are configured such that the system does not store and control public and private keys on behalf of users. The blockchain 100 is configured to perform processes that can control whether a user transfer request (from the wallet using the keys) shall proceed or be blocked. The blockchain 102 and service server 104 are configured to operate only as a “processor” and cannot transfer or instruct a transfer of a token using keys (which are stored in user wallets).

In the example of FIG. 1, the blockchain is configured to use proof of authority, implementation of which is generally known to those of ordinary skill in the art. The blockchain can be configured to uniquely identify minted individual tokens in association with an owner data record (recorded on the blockchain ledger). The blockchain is configured to change the owner data record when an individual token is transferred to a new user (to be under that user's control) using the consensus protocol and other features of blockchain 100. The blockchain would maintain a history of the transfer in the records of the blockchain.

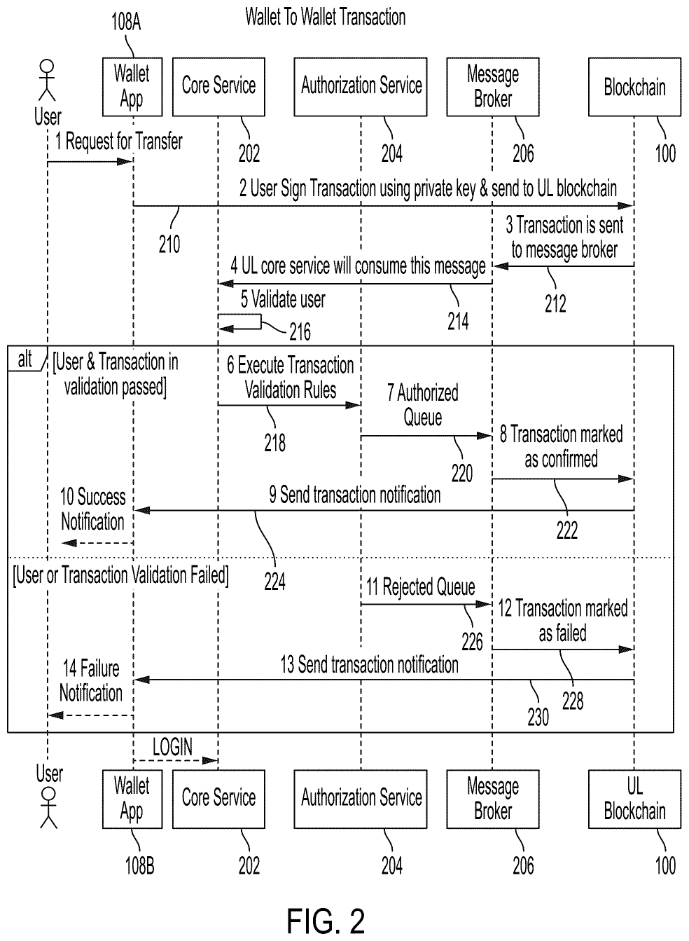

With reference now to FIG. 2, a functional block diagram combined with process flows is illustrated. In this illustration, a wallet-to-wallet token transfer is illustrated. The diagram includes core service 202, authorization service 204, and message broker 206. Core service 202, authorization service 204, and message broker 206 can be implemented on service server 104. Core service 202, authorization service 204, and message broker 206 can be software modules or applications that communicate with each other as part of running the services provided by the service server 104 in cooperation with blockchain 100.

For clarity, wallets are identified as 108A and 108B. The user of wallet 108A may interact with that wallet's GUI on the installed device to request a transfer of one or more tokens (or fractional amount) to wallet 108B of another user. The user may, for example, instruct the transfer by specifying the public key of the wallet 108B and/or other address information. If desired, wallet 108A can be configured internally and/or in combination with an API or interface application allow the user of wallet 108A to select an individual user to be the recipient of the transfer (e.g., by specifying or selecting an identifier or identity of the user of wallet 108B).

At step 210, the transfer request generated by the wallet is signed (by using an encryption key) by the wallet of the sending user and sent to blockchain 100. At step 212, the request message is received by the blockchain network 100 and the blockchain network 100 is configured to send the new request to message broker 206. The data structure of the blockchain and request may be configured to be a proposed transaction. The protocol of the blockchain can be configured to include a feature that upon receiving a proposed transaction, the request is automatically forwarded or sent to the message broker 206. It should be understood here that this may not necessarily mean that the exact same message that is received by blockchain network 100 is sent to message broker 206 but for example, it could be portions of the message that is sent such as the payload by creating a new message that contains the payload. The message broker 206 can be configured to provide message routing or distribution functions such as to send a received message, after assessing, to an appropriate module or recipient. For example, the transfer request is intended for the blockchain and/or the other user's wallet but to perform the appropriate operations, the message broker evaluates the received message to direct (routes, transmits, etc.) the message or feature accordingly. Message broker 206 can be configured to receive many different messages and operate as an event trigger that determines a particular trigger event has occurred (a transfer) and in response activates certain associates and corresponding processes. This can include the appropriate routing.

At step 214, message broker 206 sends the received message for the transfer request to the core service 202. At step 214, the core service 202 can be configured to consume the message. Core service 202 can be configured to perform various operations that determine whether the requested transfer should proceed on the blockchain network 100. Core service 202 can include a rules engine that implements many different rules that are dependent on the details of the transaction, such as, the country or local jurisdiction, user identity, transaction amount, custom-user rules, custom-company rules, or tiered rules. The rules engine receives the details of the transaction request and applies the details to the rules (applicable rules based on the transaction details) and produces an output that authorizes/validates the transfer to proceed or denies/blocks the transfer. The rules engine can be configured to include and operate many (e.g., hundreds or thousands) of different structured, connected, tiered, and/or dynamic rules. The rules can be configured to check for regulatory compliance such as a reporting requirement based on the amount of transfer, economic sanctions against the identified parties, etc. The rules can be determined based on the transaction details and performed quickly due to their predefined logical structure (e.g., using if/then type structures). This arrangement establishes in effect a security firewall by requiring the process to be behind (go through) the blockchain as opposed to for example being at the wallet level.

At step 216, core service 202, if desired, can also validate the user by confirming that that the requesting and receiving users are registered users of the system (registered to be able to receive or send that particular cryptocurrency). This can be done using described processes or by receiving information provided as part of the transfer request that corresponds (or correlates) to information saved for registered users in the service server 104. At step 218, in response to the validation of the user, core service 202 is configured to communicate the transfer details to authorization service 204. Authorization service 204 comprises the rules engine. The authorization service 204 reads the transfer details and determines the applicable set of rules that are to be processed. The authorization service is configured to apply the determined rule set to the transfer details and if the rule requirements are satisfied, authorize the transfer the proceed and accordingly communicate the authorization to message broker 206. The rules can include corresponding rule sets for different situations such as the jurisdiction of the sending and/or receiving wallet, tiered rules, government rules, or enterprise rules. The rules can be updated by the entity that saved the rules to be part of the blockchain system such as to make it be easily updated over time as law or regulations change. For example, an enterprise that provided wallets for its employees can dynamically revise the rules to set higher or lower thresholds for permitted transactions. The rules include conflict resolution rules configured to prevent certain installed rules to not be overwritten or avoided by other rules.

The blockchain system can be configured to apply tiered privileges that correspond to the system establishing higher levels of accuracy (or risk reduction), so as to provide confidence in the identity of the actual parties. For example, a first tier can be the volunteered information of the user, a second tier can be the verification by the system of identification information provided by the user, and a third tier can be the use of government issued identification and supporting identity verification such as the use of SSI. The rules engine can be configured to receive or retrieve the transferring or transferee user's identity tier and select to use the rule set that corresponds to that identity tier. In this structure for example, the system can specify escalating transfer threshold as a function of the identity tier. A user that is at the top available tier, for example, would be subject to a rule that permits the most tokens to be transferred while a lower tier would have lower thresholds. The service server 104 can be configured to monitor the activity of a user on the blockchain and apply a set of rules that determines whether the user's activity history indicates that the transfer threshold should be increased. If so, the rules engine is updated to provide for that higher threshold for that user.

This process is configured to allow blockchain 100 to use off-chain computers and applications (access on-chain, or through the blockchain) to support the operation of blockchain 100. This is performed by transmitting transfer details to the supporting off-chain computers and applications (e.g., rules engine) to conduct an evaluation of whether the transfer should proceed. The nodes on the blockchain and the supporting computers and application (e.g., service server 104) are configured to be in a trusted relationship, for example, because the connection and computers are under the administration and/or ownership of one entity. This arrangement can provide a very quick process of checking transfers that is secure and reliable, for example, because it does not rely on public nodes to run the blockchain and the operation of the supporting applications (e.g., authorization service 204). It also avoids circumvention of the transfer or transfer requirement, for example, because the on-chain process requires and embeds authentication and identity detection of the user(s) at the ledger, within the operation of the blockchain. Also, by providing a computer presence for third parties that are not directly involved in transactions (such as governments), rules can be automatically applied as required by that entity based on the transfer details in the blockchain. In known technology, systems are implemented by the entity that processes a transaction to review against government rules and regulations, which can slow the transfer process.

At step 220, the transfer in response to passing the rules set, a message is communicated to the message broker 204 instructing that the particular transfer is authorized. At step 222, message broker 206 transmits a message to blockchain 100 marking that particular transfer to be confirmed to proceed. At step 224, in response, blockchain 100 is configured to send a transaction notification to wallet 108A and/or 108B communicating that the transfer is proceeding and/or completed.

In the event that the rules engine generates a result that the fails the instructed transfer, at step 226, the rejection is communicated to the message broker 206. At step 228, the status of the transfer as failed is marked and communicated to the blockchain. At step 230, wallet 108A and/or 108B are notified of the status.

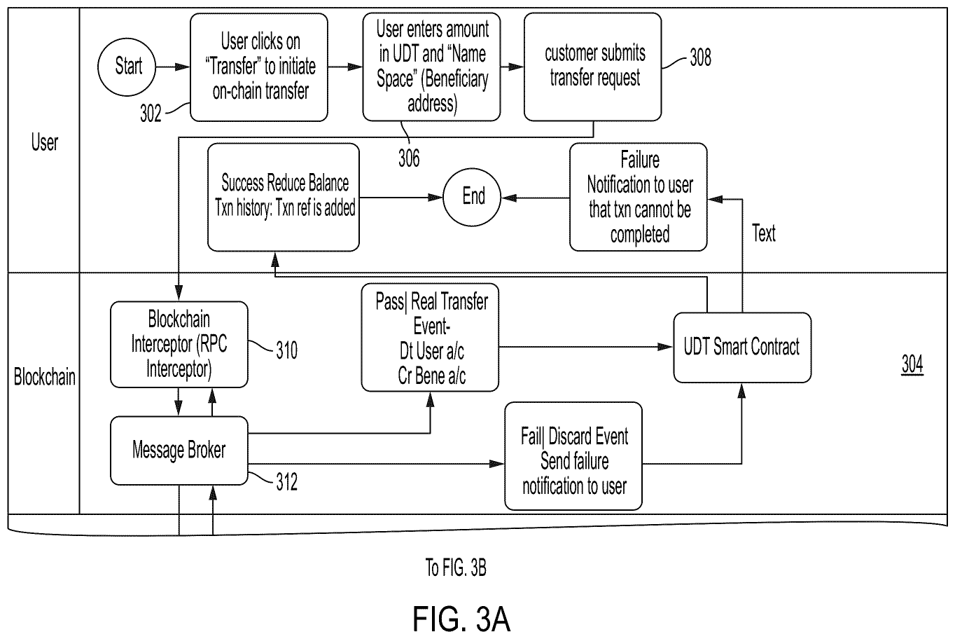

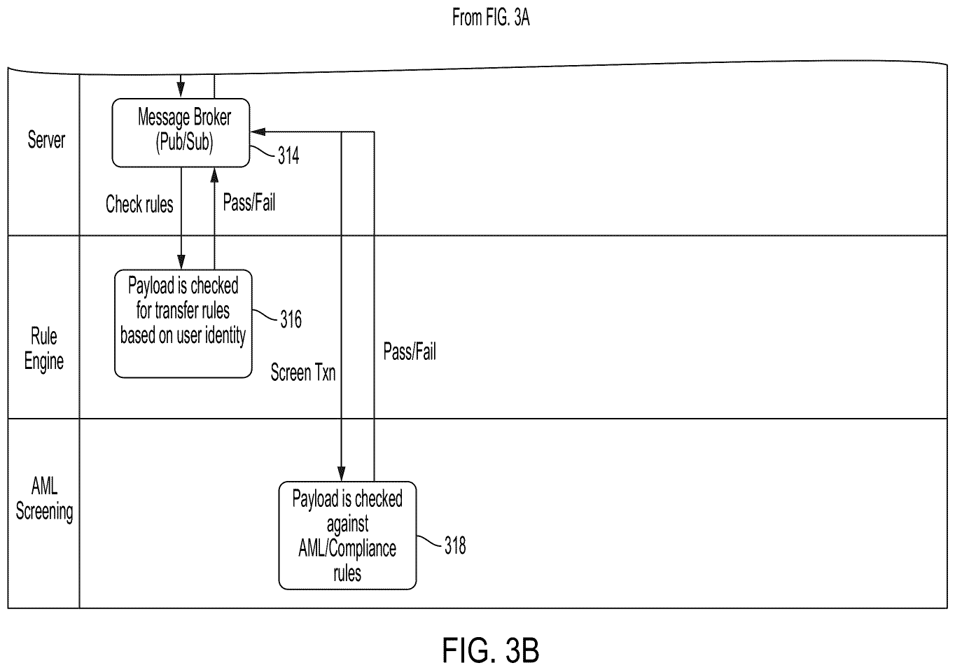

FIG. 3 is a hybrid diagram illustrating systems and features in accordance with one or more embodiments of the present invention. A step 302, an interface of the user device provides the user with the option to select to transfer the resident cryptocurrency of the blockchain 304. The selection results in initiating an on-chain transfer. At step 306, the interface of the user device provides the use with the ability to input a cryptocurrency token amount and beneficiary name. At step 308, the interface permits the user to submit the transfer request. In response, at step 308, the wallet of the user device transmits a transfer or transaction request message comprising the name and amount to the blockchain. The necessary keys may be included in the message.

Blockchain protocol implemented to operate blockchain 304 can include a blockchain interceptor 310 that is a software application or module configured on the blockchain network to be a preliminary operating layer before passing messages to nodes to perform ledger addition using the consensus protocol. Blockchain interceptor 310 is implemented on a computer and is configured to receive messages sent to the blockchain to be operated on such as token transfer requests messages and transmit received messages to other destinations in the system such as message broker 12. The blockchain network can be configured in accordance with an established or conventional blockchain protocol such as Ethereum. In embodiments of the present invention, the implementation of the established or conventional blockchain protocol is modified to include the interceptor 310 (e.g., by modifying the open source code for the blockchain standard such as the process of receiving request) that is configured to reroute or direct the message to the message broker 312 (without passing it to the blockchain network), which subsequent processes (and system(s)) control whether the message will be sent to/received by the blockchain network 100 to processes the message in accordance with the blockchain protocol. The message interceptor 310 is running/executing on a computer that is a private node of the blockchain network 100. Message broker 312 is configured in the blockchain network to operate as a router (software and/or hardware) to control the distribution of the received messages (e.g., based on the message content). The message router 312 is running/executing on a computer that is a private node of the blockchain network 100.

The redirection or interception of messages by message interceptor 310 and message router 312 can configure the addition or integration of a layer on top of the blockchain network 100. The layer for example operates as a cloud service to the blockchain network 100 to provide described features for operation on the on the blockchain network 100. The layer can configure many different servers to provide different feature by way of the direction of the messages to the layer such as implementing rules based systems that check identity, transaction threshold based on levels or “badges,” compliance rules or regulations, or government jurisdictional rules. The layer can be configured to control whether a message is passed to the blockchain network to processed. Once received (if permitted by the layer), the standard or conventional protocol of the blockchain network 100 can execute the operations for the message. The layer can for example in reference to FIG. 3 be the server, rules engine, and AML screening. The layer can then process or have rules associated with different companies or entities that are on the blockchain network system to control whether transfer request messages from their corresponding encryptions keys (e.g., sent by users associated by the company or entity) and passed to the blockchain network 100 and executed thereon (or blocked based on company or entity specific rules in that layer). The layer in discussion is “behind” the blockchain network because, for example, the messages are sent to the blockchain network using the standard or conventional protocols, but the layer then operates on the messages in conjunction with the blockchain network to provide additional server-based features that are accessible (only accessible) through communicating with the blockchain network 100.

Message broker 314 “sits” behind the blockchain 304 and receives/transmits messages with message broker 312. Message broker 314 and subsequent processes and computers involved in determining whether to allow a message to continue to the blockchain network 100 are off-chain. Off-chain means that a computer is not one of the computer nodes of the blockchain network (executing the blockchain protocol) or is a process that is running/executing on a computer is not one of the computer nodes of the blockchain network (executing the blockchain protocols). In some embodiments some combination of off-chain and on-chain are contemplated. Transaction data such as the users involved, transaction amount, jurisdiction can be passed from the request message. In some embodiments, lookup or external resources can be used to obtain data for the rules engine. At step 316, the rules engine is configured to check the payload of the message request and/or data about or related to the message request (e.g., jurisdiction for user registration if not provided in the transfer message). Step 316 can be configured to check the user's identity and/or other information such as tier level by, for example, a lookup of the user registration data (e.g., wallet address) and saved tier level (e.g., bronze, silver, etc.). To demonstrate, a transaction threshold of $50 may be set for bronze and $200 for sliver. The rules engine can be configured to pass or fail the transfer request if the tier of the register user (transferor) does not have a sufficient monetary privilege for the request. At step 318, a second set of rules is configured to be applied to the transfer. The rules can be compliance or otherwise such as to check whether the transaction is permitted in or for an involved, specified, or applicable jurisdiction.

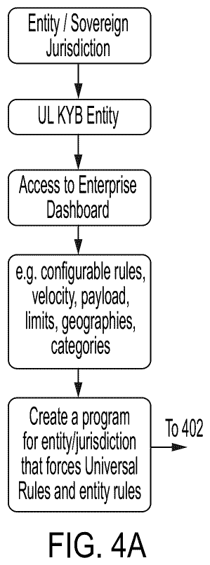

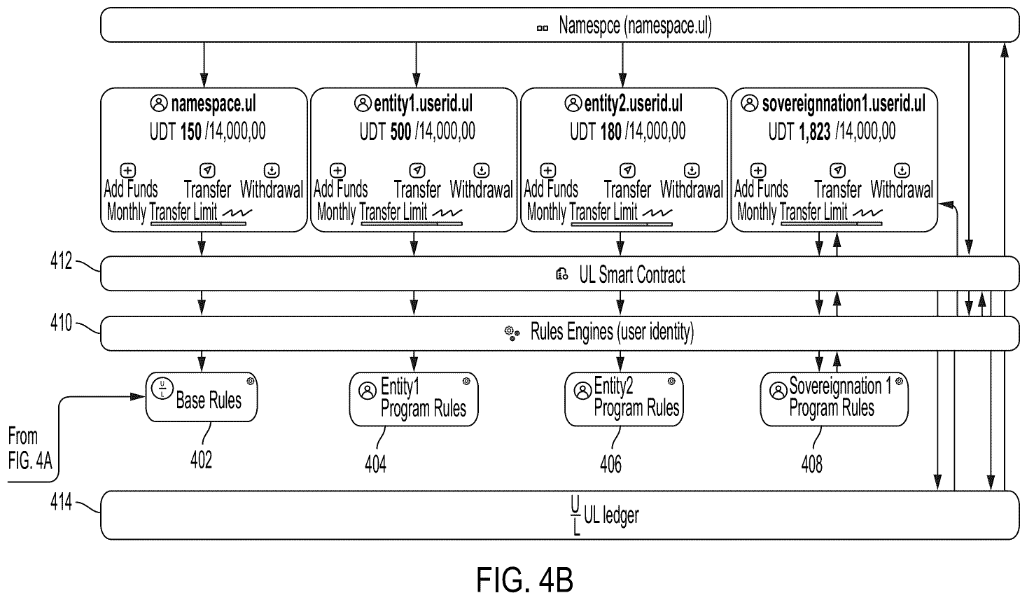

With reference now to FIG. 4, a functional block diagram and process flow is provided that illustrates the ability of the system to have connection with third parties that are able to configure and update their own rules on the system (blockchain). Governments, employers, or other entities can be provided with access on the system to load and update the rules that are to be used for applicable transactions such as due to a particular jurisdiction or because the transaction involves employees of an entity. This ability to have a presence on the system can provide a valuable tool that makes the transfer process more efficient, for example. As shown, base rules 402 are configured by the token and system provider such as to limit certain transfers. Entity 1 may have program rules 404, that the Entity can create and store on the system or through an authorized communication with the system. This can be the same Entity 2 406. Also, a sovereign government can program rules 408 that are created and stored on the system or through authorized communication with the system. The third parties may have a server of their own that stores their rules and communicates the rules to a storage on the system. In the illustrated embodiment, the system entity or government program rules would be available when they are loaded in the system (e.g., using rule structures specified for the system) and the rules would be executed by the system, for example, without requiring the system to accept or approve the loaded entity specific rules. Rules engine 410 may have its own set of rules (e.g., determine or confirm user identity) and may also operate as a communication channel for performing the entity's provided rules such as rules 404, 406, and 408. As shown smart contract 412 is illustrated separate from ledger 414 for that particular token. To clarify, however, the smart contracts are on-chain and are executed on-chain. The system relies on the rules engines 402, 404, 406, 408, and 410, to for example, generate an output that is used by the smart contact 412 to determine whether the transaction is to be completed and ledger 414 updated as a result.

The terms may or can are used to include other implementations are contemplated. This is not to say that use of terms such as “is” or “are” are limiting. Those are also used in an illustrative non-limiting sense.

A computer system, sometimes referred to as a computer or computer device, including for example a server, a mobile phone, tablet, etc. can be used to implement embodiments of the present invention.

A computer system can be implemented using on one or more computer systems and be configured to communicate over a network. In one embodiment, the computer system includes a bus or other communication mechanism for communicating information, and a hardware processor coupled with bus for processing information. A computer or device can be configured to implement a plurality of instances of computers (e.g., virtual computers). For example, a server rack can provide many computers. Blockchain nodes can be implemented for example by a graphical processing unit of a computer. However, it is noted that in some embodiments having separate and/or distinct computers or computer systems is or is understood to be part of the disclosed embodiments such as having separate and/or distinct private computer for the blockchain versus other mentioned computers such as public computers, personal computer devices, and/or third party computers that have external access for configuring their own distinct rule engines.

The computer system also includes a main memory, such as a random access memory (RAM) or other dynamic storage device, coupled to bus for storing information and instructions to be executed by processor. Main memory also may be used for storing temporary variables or other intermediate information during execution of instructions to be executed by processor. Such instructions, when stored in non-transitory storage media accessible to processor, render computer system into a special-purpose machine that is customized to perform the operations specified in the instructions.

The computer system further includes a read only memory (ROM) or other static storage device coupled to bus for storing static information and instructions for processor. A storage device, such as a magnetic disk or optical disk, is provided and coupled to bus for storing information and instructions.

The computer system may be coupled via bus to a display, such as a computer monitor, for displaying information to a computer user. An input device, including alphanumeric and other keys, is coupled to bus for communicating information and command selections to processor. Another type of user input device is cursor control, such as a mouse, a trackball, or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

The computer system may implement the techniques described herein using customized hard-wired logic, one or more ASICs or FPGAs, firmware and/or program logic which in combination with the computer system causes or programs computer system to be a special-purpose machine. According to one embodiment, the techniques herein are performed by the computer system in response to the processor executing one or more sequences of one or more instructions contained in main memory. Such instructions may be read into main memory from another storage medium, such as storage device. Execution of the sequences of instructions contained in main memory causes the processor to perform the process steps described herein. In alternative embodiments, hard-wired circuitry may be used in place of or in combination with software instructions.

The term storage media (or memory) as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device. Volatile media includes dynamic memory, such as main memory. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus. Transmission media can also take the form of acoustic or light waves, such as those generated during radio-wave and infra-red data communications.

Various forms of media may be involved in carrying one or more sequences of one or more instructions to the processor for execution. For example, the instructions may initially be carried on a magnetic disk or solid state drive of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on bus. Bus carries the data to main memory, from which processor retrieves and executes the instructions. The instructions received by main memory may optionally be stored on storage device either before or after execution by the processor.

The computer system also includes a communication interface coupled to bus. The communication interface provides a two-way data communication coupling to a network link that is connected to a local network. For example, the communication interface may be an integrated services digital network (ISDN) card, cable modem, satellite modem, or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

Network link typically provides data communication through one or more networks to other data devices. For instance, network link may provide a connection through local network to a host computer or to data equipment operated by an Internet Service Provider (ISP). ISP in turn provides data communication services through the worldwide packet data communication network now commonly referred to as the “Internet.” Local network and Internet both use electrical, electromagnetic or optical signals that carry digital data streams. The signals through the various networks and the signals on network link and through the communication interface, which carry the digital data to and from the computer system, are example forms of transmission media.

The computer system can send messages and receive data, including program code, through the network(s), network link and the communication interface. In the Internet example, a server might transmit a requested code for an application program through Internet, ISP, local network and the communication interface.

The received code may be executed by the processor as it is received, and/or stored in storage device, or other non-volatile storage for later execution.

It is understood from the above description that the functionality and features of the systems, devices, or methods of embodiments of the present invention include generating and sending signals, packets, or messages to accomplish the actions.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention. Applications of the technology to other fields are also contemplated.

Thus, for example, any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the systems illustratively described herein provide computer-implemented functionality that automatically performs a process or process step.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

It should be understood that combinations of described features or steps are contemplated even if they are not described directly together or not in the same context.

Software applications can be implemented as distinct modules or can be integrated together into an overall application such as one that includes the user interface and that handles other features for providing the functionality to the user on his device.

It is intended that the specification and examples be considered as exemplary only, with a true scope being indicated by the claims and their equivalents.

1. A system comprising,
a plurality of computer nodes that are configured to be private computers and to form a blockchain that operates cooperatively in accordance with a decentralized peer-to-peer blockchain consensus protocol that governs creating, transferring, and maintaining a history of a particular token type resident on that blockchain;
a service server that is configured to receive information from a plurality of electronic software applications, wherein the software applications are configured to securely store user data as an electronic container and the user data includes encryption keys that are assigned to the user of that software application to control access in association with the particular token type on that blockchain and, wherein the service server is configured to store user registration and user identification and is further configured to store a corresponding identification tier from a plurality of tiers;
wherein the blockchain is configured receive a new token transfer request message and, to proceed when the identity of the a user that sent the request message and receiving user are known by the service server; further wherein, the computer nodes on the blockchain are configured to direct the request message to an off-chain computer, wherein the off-chain computer is configured to include a rules engine comprising different sets of rules directed to providing dynamic evaluation of transfer request messages, and wherein a portion of the rules are structured to vary as a function of the identification tier of the user that sent the request message or receiving user, and another set of rules are configured to apply other rules controlled by external electronic access to the rules engine; and
further wherein, the system implements an automatically executable set of code stored and executable on the blockchain, wherein the automatically executable set of code is configured to receive the output of the rules engine and is configured to have the system select one of blocking or proceeding with a new token transfer as specified in the new token transfer request message and wherein, in response to determining to proceed, the blockchain uses a consensus protocol defined in the decentralized peer-to-peer blockchain consensus protocol to record on the blockchain the token transfer; and
wherein the protocol configures the nodes to respond to requests to receive blockchain audit data sent from a public computer.

2. The system of claim 1 wherein the service server is configured to administer the plurality of computer nodes.

3. The system of claim 1 wherein the protocol configures the nodes to send data stored on the blockchain to a requesting public computer.

4. The system of claim 3 wherein the public computer is the service server.

5. The system of claim 1 wherein an application program interface is implemented on personal devices to participate in the operation on the blockchain.

6. The system of claim 1 wherein the system includes a computer that is configured to intercept messages sent to the blockchain and directs one or more the messages to the off-chain computer.

7. The system of claim 1 wherein the system is configured to include a plurality of separate different rules engines that are controlled or defined by different external computers.

8. A computer-implemented method comprising,
providing a plurality of computer nodes that are configured to be private computers and to form a blockchain that operates cooperatively in accordance with a decentralized peer-to-peer blockchain consensus protocol that governs creating, transferring, and maintaining a history of a particular token type resident on that blockchain;
configuring a service server to receive information from a plurality of electronic software applications, wherein the software applications are configured to securely store user data as an electronic container and the user data includes encryption keys that are assigned to the user of that software application to control access in association with the particular token type on that blockchain, to store user registration and user identification, and to store a corresponding identification tier from a plurality of tiers;
receiving a new token transfer request message and, proceed when the identity of a user that sent the request message and receiving user are known by the service server;
configuring the computer nodes on the blockchain to direct the request message to an off-chain computer, wherein the off-chain computer is configured to include a rules engine comprising different sets of rules directed to providing dynamic evaluation of transfer request messages, and wherein a portion of the rules are structured to vary as a function of the identification tier of the user that sent the request message or receiving user, and another set of rules are configured to apply other rules controlled by external electronic access to the rules engine; and
implementing an automatically executable set of code stored and executable on the blockchain, wherein the automatically executable set of code is configured to receive the output of the rules engine and is configured to have the system selective one of blocking or proceeding with a new token transfer as specified in the new token transfer request message;
in response to determining to proceed, using a consensus protocol defined in the decentralized peer-to-peer blockchain consensus protocol to record on the blockchain the token transfer; and
configuring the nodes to respond to requests to receive blockchain audit data sent from a public computer.

9. The method of claim 8 comprising administering, using service server, the plurality of computer nodes.

10. The method of claim 8 comprising configuring the nodes to send data stored on the blockchain to a requesting public computer.

11. The method of claim 10 wherein the public computer is the service server.

12. The method of claim 8 wherein implementing an application program interface on personal devices to participate in the operation on the blockchain.

13. The method of claim 8 wherein the system includes intercepting messages sent to the blockchain and directing one or more the messages to the off-chain computer.

14. The method of claim 8 comprising implementing a plurality of separate different rules engines that are controlled or defined by different external computers.

15. A computer readable non-transitive medium comprising computer readable instructions that are executable by a computer to implement a method that when executed by computer performs steps comprising,
implementing a plurality of computer nodes that are configured to be private computers and to form a blockchain that operates cooperatively in accordance with a decentralized peer-to-peer blockchain consensus protocol that governs creating, transferring, and maintaining a history of a particular token type resident on that blockchain;
configuring a service server to receive information from a plurality of electronic software applications, wherein the software applications are configured to securely store user data as an electronic container and the user data includes encryption keys that are assigned to the user of that software application to control access in association with the particular token type on that blockchain, to store user registration and user identification, and to store a corresponding identification tier from a plurality of tiers;
receiving a new token transfer request message and, proceed when the identity of the user that sent the request message and receiving user are known by the service server;
configuring the computer nodes on the blockchain to direct the request message to an off-chain computer, wherein the off-chain computer is configured to include a rules engine comprising different sets of rules directed to providing dynamic evaluation of transfer request messages, and wherein a portion of the rules are structured to vary as a function of the identification tier of the user that sent the request message or receiving user, and another set of rules are configured to apply other rules controlled by external electronic access to the rules engine; and
implementing an automatically executable set of code stored and executable on the blockchain, wherein the automatically executable set of code is configured to receive the output of the rules engine and is configured to have the system selective one of blocking or proceeding with a new token transfer as specified in the new token transfer request message;
in response to determining to proceed, using a consensus protocol defined in the decentralized peer-to-peer blockchain consensus protocol to record on the blockchain the token transfer; and
configuring the nodes to respond to requests to receive blockchain audit data sent from a public computer.

16. The computer readable medium of claim 15 wherein the steps comprising administering, using service server, the plurality of computer nodes.

17. The computer readable medium of claim 15 wherein the steps configuring the nodes to send data stored on the blockchain to a requesting public computer.

18. The computer readable medium of claim 17 wherein the service server is the public computer.

19. The computer readable medium of claim 15 wherein the steps comprising implementing an application program interface on personal devices to participate in the operation on the blockchain.

20. The computer readable medium of claim 15 wherein the steps comprising intercepting messages sent to the blockchain and directing one or more the messages to the off-chain computer.

21. The computer readable medium of claim 15 wherein the steps comprising implementing a plurality of separate different rules engines that are controlled or defined by different external computers.
